(19) United States
(12) Patent Application Publication
(10) Pub. No.: US 2015/0003094 A1
(43) Pub. Date: Jan. 1, 2015

(54) MOTOR VEHICLE LIGHTING DEVICE WITH A COUPLING LENS AND A TRANSPORT AND CONVERSION LENS

(71) Applicant: Automotive Lighting Reutlingen GmbH, Reutlingen (DE)

(72) Inventors: Matthias Gebauer, Reutlingen (DE); Dominik Schott, Ammerbuch (DE)

(21) Appl. No.: 14/312,768

(22) Filed: Jun. 24, 2014

(30) Foreign Application Priority Data
Jun. 26, 2013 (DE) 10 2013 212 352.3

(51) Int. Cl. F21S 8/10

(52) U.S. Cl. CPC F21S 48/1241
USPC 362/511

(57) ABSTRACT

A motor vehicle lighting equipment with a light source and an optical fiber arrangement, having an input coupler and a transport and transformation lens system. The input coupler has a curved light beam forming surfaces, which reduces the angle of beam of the light in these second sectional planes when penetrating the surface. The transport and transformation lens system has transformation lenses which have a mutual focal point. The light source is located in the mutual focal point. The light source is arranged in such a way on the side of the optical fiber arrangement located opposite of the light-emitting surface that all areas of the optical fiber arrangement conducting light from the light source are located between the light source and the light-emitting surface, and the one planar deflection area is arranged between the curved surfaces of the input coupler and the transformation lenses.

### CROSS-REFERENCE TO RELATED APPLICATION

This application is based upon and claims priority to German Patent Application DE 102013212352.3 filed on Jun. 26, 2013.

### BACKGROUND OF THE INVENTION

1. Field of Invention

The present invention relates generally to lighting equipment for motor vehicles and, more specifically, to lighting equipment with a coupling lens and a transport and conversion lens.

2. Description of Related Art

Motor vehicle lighting equipment known in the art typically includes a light source and an optical fiber arrangement, which has an input coupler and a transport and transformation lens system. The transport and transformation lens system includes a light-emitting surface, and the input coupler is configured to transform a light beam emitted by the light source and direct it to the transport and transformation lens system. The input coupler has at least one curved light beam forming surface which has, in first sectional planes, semi-circular edges with central points located on an axis, on which the light source is also located. The curved light beam forming surface has at least one surface in second sectional planes with a lens-shaped profile, which reduces the angle of beam of the light in these second sectional planes when penetrating the surface. The transport and transformation lens system includes transformation lenses wherein the angle of beam of the light originally spreading in the first planes is reduced before impinging the light-emitting surface. An optical fiber including these characteristics is known from Published German Patent Application DE 19925263 A1. The optical fiber known in the art is plate-shaped and has extended boundary surfaces that are located parallel to one another and small lateral surfaces that connect the plate-shaped boundary surfaces with one another. One of the small lateral surfaces is used as a light-emitting surface which extends in one embodiment over the entire width of the circuit board and therefore has an elongated rectangular and, thus, band-shaped form. The input coupler involves a recess in the circuit board shaped like a round hole. The boundary surface of this recess used as light incidence area of the optical fiber does not have a rotation-symmetric form. A light source is arranged in the interior of the recess.

To achieve a parallel light propagation in the optical fiber in the direction of the light-emitting surface, the well-known optical fiber provides that a reflector located opposite of the band-shaped light-emitting surface includes parabolic profiles in the planes situated parallel to the extended panel surfaces and prism-like profiles perpendicular to the extended panel surfaces, in which light is deflected twice, propagating the deflected light in the direction of the light-emitting surface. The light source is arranged in the focal point of the parabolic profile. As a result, the reflector directs the light arriving in a large angle of beam as parallel light of the surfaces to the band-shaped light-emitting surface located opposite of the reflector.

The optical fiber is disadvantageous in that that directly into the half-space facing the light-emitting surface, radially emitted light of the light source is not impinging the first reflector and, therefore, is not aligned in parallel fashion. However, to be used in lighting equipment of motor vehicles, either for headlight functions or for signal light functions, a light emitting surface is required where light is illuminated as parallel as possible and as homogenous (uniformly bright) as possible. For example, such light has the advantage that it can be distributed in an especially easy manner in rule-consistent light distributions with light distribution lenses in the light-emitting surface and/or with light of subsequent lenses emitted in the beam path of the light-emitting surface. Moreover, from design-relevant aspects, an optical fiber is desired which has a band-shaped light-emitting surface with a large length/width ratio of the light-emitting surface and which fulfills the requirements discussed above (homogeneity, parallelism).

### SUMMARY OF THE INVENTION

The present invention overcomes the disadvantages in the related art in motor vehicle lighting equipment with a light source and an optical fiber arrangement, which has an input coupler and a transport and transformation lens system. The transport and transformation lens system includes a light-emitting surface, and the input coupler is configured to transform a light beam emitted by the light source and direct it to the transport and transformation lens system. The input coupler has at least one curved light beam forming surface which has a lens-shaped profile, which reduces the angle of beam of the light when penetrating this surface. The transport and transformation lens system has transformation lenses that have a mutual focal point, and the light source is arranged in the mutual focal point. The light source is arranged in such a way on the side of the optical fiber arrangement located opposite of the light-emitting surface that all areas of the optical fiber arrangement conducting light from the light source are located between the light source and the light-emitting surface. Further, the optical fiber arrangement has at least a planar deflection area which is arranged between the curved surfaces of the input coupler and the transformation lenses.

In the related art, however, the light source is located inside the optical fiber in such a way that it divides the optical fiber in a first section located between the light source and the light-emitting surface and a second section located between the end of the optical fiber facing away from the light-emitting surface and the light source. This position is responsible for the disadvantages described above because the light spreading in the first section is not transformed or transformed in a different manner than the light spreading in the second section, which experiences a direction reversal and parallelization by the parabolic roof-edge reflector. However, in the invention, all light of the light source enters the same optical fiber volume and can be subsequently transformed with the same transformation lenses without requiring some of the light to be guided in reverse direction. With the planar deflection area, the direction of input light becomes independent from the direction of the light-emitting surface so that the light source with its primary beam direction can be positioned in the space relatively free, even when the light-emitting surface has a definite position. The fact that the deflection area is a plane surface has the advantage that the light beam is deflected as a whole without having to change the angular distribution within the beam. This has the advantage that the transformation lenses following in the optical path do not have to be changed even when the deflection angle has to be structurally adjusted to different installation space conditions.

In one embodiment, in first sectional planes, the curved light beam forming surfaces has semi-circular edges with central points that are located on an axis on which also the light source is arranged, and, in second sectional planes, the surfaces have a lens-shaped profile. It is also preferred that the input coupler has a lens and that the light-emitting surface of the lens is a curved light beam forming surface. Furthermore, it is preferred that the input coupler has an auxiliary lens with a central light-ingress surface, lateral light incidence areas, and lateral reflection surfaces, wherein the central light incidence area is a curved light beam forming surfaces. In one embodiment, the input coupler has an auxiliary lens with a central light incidence area, lateral light incidence areas, and lateral reflection surfaces, wherein the lateral reflection surface is a curved light beam forming surface.

It is also preferred that the input coupler and the transport and transformation lens system are integrally formed, firmly bonded components of the optical fiber arrangement. Alternatively, it is preferred that the input coupler and the transport and transformation lens system are separate components which are detachably or non-detachably connected with the optical fiber arrangement. Furthermore, it is preferred that the deflection area is part of a separate input coupler component of the optical fiber arrangement. It is also preferred that the deflection area is a component of a separate transport and transformation lens system component of the optical fiber arrangement. Furthermore, it is preferred that the transformation lens has a central air lens and/or that it is implemented in the form of parabolic and internally fully reflective boundary surfaces of inner recesses and/or in the form of parabolic and internally fully reflective outer reflectors. In one embodiment, all transformation lenses have the same focal point. It is also preferred that light distribution lenses are integrated in the light-emitting surface. Furthermore, it is preferred that the shape of a spatial auxiliary lens profile is produced by extruding a planar auxiliary lens profile. It is also preferred that the form of a spatial auxiliary lens profile is produced by rotating a planar auxiliary lens profile. In one embodiment, the motor vehicle lighting equipment has an internal air lens in the form of a Fresnel lens that is used as a transformation lens.

### BRIEF DESCRIPTION OF THE DRAWINGS

Other objects, features, and advantages of the present invention will be readily appreciated as the same becomes better understood after reading the subsequent description taken in connection with the accompanying drawing wherein:

FIG. 1 shows a longitudinal section of an embodiment of lighting equipment according to the present invention.

FIG. 2 shows a cross-section of an input coupler.

FIGS. 3A-3D show different views of an optical fiber arrangement of the type of objects shown in FIGS. 1 and 2.

FIG. 4 shows a design of an optical fiber arrangement with an input coupler in the form of a lens.

FIG. 5 shows a perspective view of an optical fiber arrangement with an input coupler in the form of a lens.

FIGS. 6A-6D show different views of the optical fiber arrangement of FIG. 5.

FIG. 7 shows a perspective view of an optical fiber arrangement which has an input coupler with an auxiliary lens profile.

FIG. 8 shows an embodiment of an optical fiber arrangement with an auxiliary lens profile.

FIG. 9 shows a perspective view of one embodiment of an optical fiber arrangement with a transformation lens in the form of a Fresnel air lens.

FIGS. 10A-10B show embodiments of separate coupling modules having a stepped light-emitting surface.

FIG. 11 shows an embodiment of a light-emitting surface which is curved in sections and which is produced by a sequence of multiple light-emitting surfaces of individual optical fiber arrangements.

FIG. 12 shows an embodiment which homogenously illuminates a curved plate with an auxiliary lens-like coupling module and respective deflection.

FIG. 13 shows a circuit board which is partially curved and partially planar.

### DETAILED DESCRIPTION OF THE INVENTION

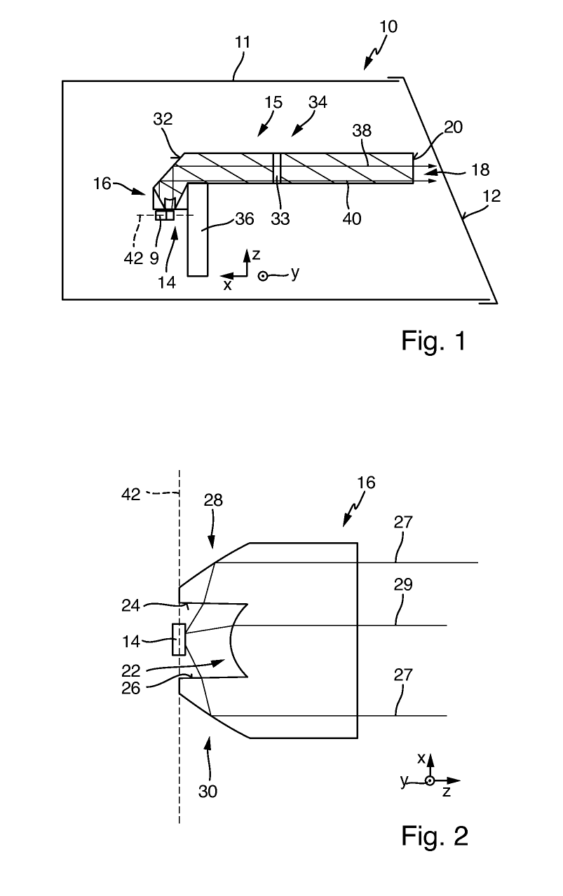

The same reference numerals in the different Figures respectively refer to the same elements or elements that have at least a comparable function. FIG. 1 shows lighting equipment 10 for a motor vehicle and with a housing 11, which has a light-emitting aperture covered with a transparent cover screen 12. In the interior of the housing, a stationary light source 14 is located, as well as an optical fiber arrangement 15 with an input coupler 16 and a transport and transformation lens system 18. At least in the light-conducting areas of the light source, the input coupler 16 and the transport and transformation lens system 18, include a transparent fiber optic material, such as PC, PMMA, glass, COC or a similar transparent material.

On one end, the transport and transformation lens system includes a light-emitting surface 20. The light source 14 may be a semiconductor light source, especially a light-emitting diode or an array of multiple light-emitting diodes. Each individual light-emitting diode may have a planar light-emitting surface, and the light-emitting surfaces may be rectangular and have an edge length of approximately between 0.3 mm and 2 mm. A light-emitting diode with such a light-emitting surface can be considered as a Lambertian radiator, which has a primary beam direction perpendicular to the light-emitting surface of the light-emitting diode and which incidentally has a wide open light beam radiating in the half-space located above the light-emitting surface. The light-emitting diodes can generate light of the same color. In a different embodiment, different light-emitting diodes generate light with different colors, wherein one light-emitting diode, respectively, generates light of one particular color.

The optical fiber arrangement 15 is configured to transform the wide open light beam of diverging rays into a beam of rays 11, 13 aligned as parallel as possible and to distribute these rays as even as possible on the light-emitting surface 20. The objective is to illuminate from the inside this light-emitting surface 20 with parallel light as homogenous as possible. With light distribution lenses, it is easy to transform such light beam into a rule-consistent light distribution which, in the intended use of the lighting equipment as an indicator lamp of a motor vehicle has a horizontal angular width of +/−20° C. and a vertical angular width of +/−10° C. In one embodiment, such light distribution lenses are implemented in the light-emitting surface 20 in the form of cushion-shaped structures or sectional cylinder jacket structures.

In use, the x-direction, which corresponds to the primary beam direction of the light-emitting surface 20, runs parallel to a forward driving direction or backward driving direction of a motor vehicle, while the y-direction is aligned in parallel to the transverse axis and the z-direction in parallel to the vertical axis of the motor vehicle. Subsequently, one embodiment of an input coupler 16 is described with reference to FIG. 2.

FIG. 2 shows a cross-section of an input coupler 16 located in the x, z plane. In this case, the input coupler 16 involves a so-called auxiliary lens. It has a central light incidence area 22, lateral light incidence areas 24, 26 and lateral reflection surfaces 28, 30. The central light incidence area 22 is located transverse to the primary beam direction of a light source 14, and the lateral light incidence areas are located rather parallel than transverse to the primary beam direction. The lateral reflection areas 28, 30 are arranged in such a way that they are illuminated by light which enters the input coupler 16 via the lateral light incidence areas 24, 26.

Moreover, the shape and arrangement of the lateral reflection areas 28, 30 is specified in such a way that the incident light 27 of the light source 14 experiences total internal reflection, and the reflected light is aligned in parallel and parallel to the light 29 entering via the central light incidence area 22. In one embodiment, the reflection areas are provided with a reflective coating. However, an implementation without such coating is preferred, because such coatings are complex to produce and therefore quite expensive. This applies to all reflecting surfaces mentioned in the present application. In addition, total internal reflections have lower light losses. The central light incidence area 22 has a lens-shaped profile and reduces the aperture angle of the light penetrating through this surface. Preferably, the aperture angle reduction takes place in such a way that the input light in the drawing plane is aligned in parallel.

The following description has reference to FIG. 1. The optical fiber arrangement has a planar deflection area 32. The transport and transformation lens system 18 has transformation lenses 34. For example, the transformation lens 34 involves an air lens 33 in the interior of the transport and transformation lens system. In the example shown, the air lens has a concave planar shape in propagation direction of the light. Independent of its special design, the shape has to fulfill the requirement that the air lens parallelizes the light propagated from the deflection area 32 to the light-emitting surface to a direction transverse to the drawing plane. A parallelization indicates a reduction of the aperture angle. It is preferred that the parallelization takes place to an extent that results in a light beam configured in parallel in this direction.

Transformation lenses can also involve reflecting surfaces of recesses located in the interior of the transport and transformation lens system. Preferably, such surfaces have a parabolic form. Alternatively or additionally, the transport and transformation lens system 18 can also involve reflecting or preferably parabolic external surfaces. Preferably, the transformation lenses have a mutual focal point. It is preferred that the light source is located in the mutual focal point. In the embodiment shown, the input coupler 16 and the transport and transformation lens system 18 are integrally formed, firmly bonded components of the optical fiber arrangement 15. However, the integral assembly is not a requirement. In different embodiments, both elements are separate components which are detachably or non-detachably connected with the optical fiber arrangement. The deflection area can be implemented as an element of a separate input coupler component or as an element of a separate transport and transformation lens system.

The light source 14 is attached on a side that is located opposite of the light-emitting surfaces 20, especially at an end of the optical fiber arrangement that is located opposite of the light-emitting surfaces 20. As a result, all areas of the optical fiber arrangement which conduct light of the light source 14 that contributes to illuminating the light-emitting surface are located between the light source and the light-emitting surface. For example, this excludes embodiments with roof-edge reflectors of the type used in the above-mentioned prior art. The planar deflection area is located between the curved surface of the input coupler and the transformation lenses. A mounting pin 36 is used to fix the optical fiber arrangement in the housing 11. The optical fiber arrangement has additional support structures 9.

FIG. 1 shows a light beam 38 entering the input coupler via the central light incidence area of the input coupler 16 and a light beam 40 entering the input coupler via a lateral light incidence area. Both light beams 38, 40 are directed via the planar deflection area 32 on the light-emitting surface 20. As a result, the input coupler is configured to transform a light beam coming from the light source and direct it to the transport and transformation lens system. The deflection area 32 is a planar surface and therefore deflects the incident light beam as a whole without changing the angular distribution of the individual rays within the beam in relation to one another. Therefore, the reflected beams are again parallel beams.

In a one embodiment, the light-transforming surfaces 22, 28 and 30 of the input coupler in the space are produced by rotating the cross-section shown in FIG. 2 about the rotation axis 42 shown in FIGS. 1 and 2 which extends through the light-emitting surface of the light source 14 and which is perpendicular to the primary beam direction of the light source. At the same time, the rotation takes place 90° into the drawing lane and 90° out of the drawing plane, respectively. Such an input coupler is parallelizing the light of the light source not only in the drawing plane, but on all potential levels opened by the rotation axis and a radius extending from the rotation axis. Such planes are subsequently also called radial planes.

Because of its refractive effect and total internal light reflection, the subject matter of FIGS. 1 and 2 is parallelizing in the radial planes the light emitted by the light source and fed into the optical fiber arrangement.

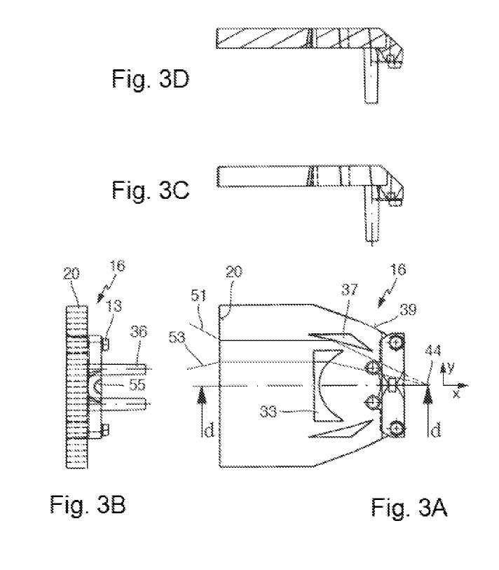

FIGS. 3A-3D show different views of an optical fiber arrangement of the type of optical fiber arrangements shown in FIGS. 1 and 2. FIG. 3A shows a top view of the optical fiber arrangement 16. In the plane shown in this view, the light beams also feature the angular distribution in relation to one another with which they entered the optical fiber arrangement 16. In these planes, parallelization takes place with the transformation lenses 34 which are here implemented in the form of a central air lens 33, parabolic and internally fully reflective boundary surfaces of inner recesses 37 and in the form of parabolic and internally fully reflective outer reflectors 39. Preferably, all transformation lenses 34 have the same focal point which is geometrically located in the virtual picture 44 of the light source 14 arranged in the real focal point. The point in which the light beams 51, 53 of FIG. 3A intersect is the location of the light source which is reflected at the deflection area and which is arranged in the real focal point. Preferably, all transformation lenses 34 have the same focal point which is geometrically located in the virtual picture 44 of the light source.

FIG. 3B shows a frontal view of the optical fiber arrangement 16 including the light-emitting surface 20. The dotted structure within the light-emitting surface 20 represents light distribution lenses that have been integrated there. Analogous this applies to the corrugated course of the light-emitting surface 20 shown in FIG. 3A. The semi-circular profiles represent edges of the input coupler 16. FIG. 3C shows a lateral view of the optical fiber arrangement and FIG. 3D shows an intersection along the plane d-d sown in FIG. 3A. The round profiles 55 are profiles of the surfaces produced by the rotation about the rotation axis 42 shown in FIG. 2.

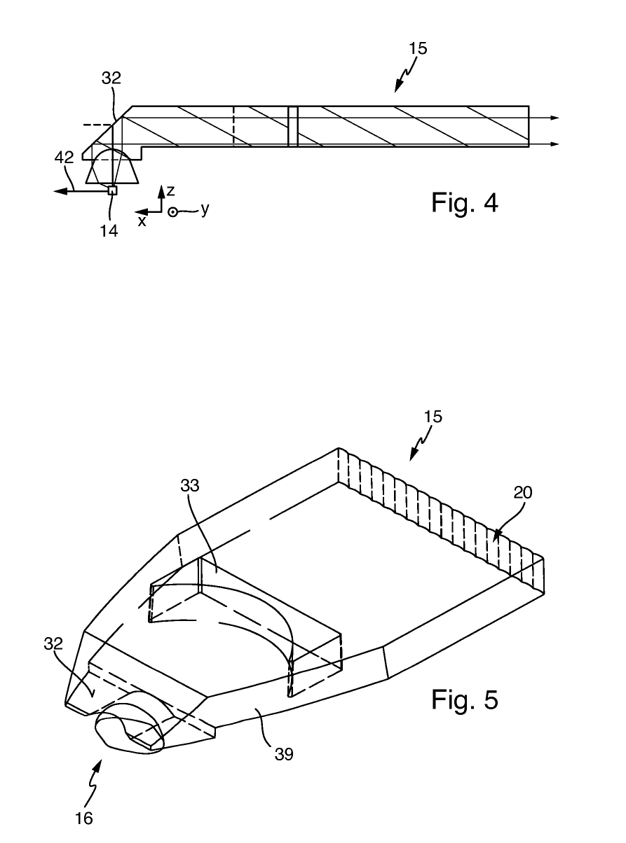

FIG. 4 shows an embodiment of an optical fiber arrangement using a lens as input coupler 16. It applies to the embodiment with the auxiliary lens, as well as to the embodiment with the lens, that the curved light beam forming surfaces has in first sectional planes semi-circular edges (for example, the edges 55 shown in FIG. 3B) with circle centers that are located on an axis 42 on which also the light source is arranged. The first sectional planes are parallel to the drawing plane of FIG. 3B. For example, in FIG. 3B, these semi-circular edges are shown in the form of edges of the input coupler 16. It also applies to both embodiments that these surfaces have a lens-shaped profile in second sectional planes. FIGS. 2 and 4 show the second sectional planes to be parallel to the drawing plane. FIG. 2 shows the embodiment with the auxiliary lens, and FIG. 4 the embodiment with the lens in the form of a planar to convex lens. In the case of the auxiliary lens, its light-emitting surface of the lens is a curved light beam forming surfaces. In the case of the auxiliary lens, its central light-emitting surface 22 is such a curved light beam forming surfaces. Furthermore, in the case of the auxiliary lens, also their lateral reflection surfaces are such curved light beam forming surfaces.

FIG. 5 shows a perspective view of an optical fiber arrangement which uses an input coupler in the form of a lens. Parallelization takes place with the lens in the radial planes. After deflection at the planar deflection area, further parallelization takes place with an internal air lens and with the outer parabolic profiles. Also in this case it applies that the transformation lenses have the same virtual focal point and the same real focal point, wherein the light source is arranged in the real focal point. The virtual focal point results in that the real focal point is reflected on the planar deflection area 32.

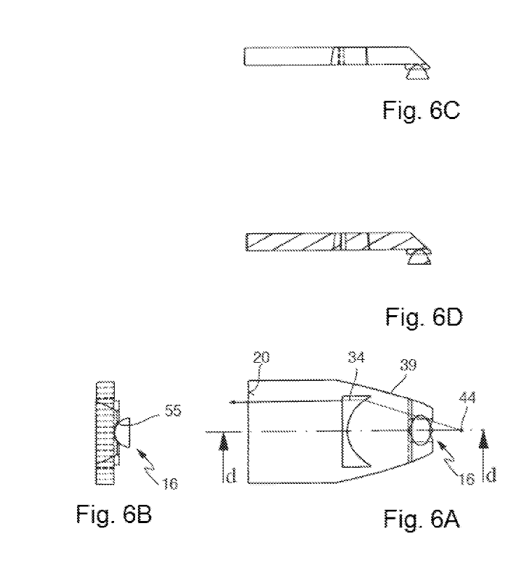

FIGS. 6A-6D show different views of the subject matter of FIG. 5. FIG. 6A shows a top view on the optical fiber arrangement 15. In the plane shown in this view, the light beams have the same angular distribution in relation to one another that they had when they entered the optical fiber arrangement 16. In this respect, the description provided for FIGS. 3A-3D can also be applied in this case. In these planes, parallelization take place with the transformation lenses 34 which are implemented here in the form of central air lens 34 and parabolic and internally fully reflective outer reflectors 39. Preferably, all transformation lenses 34 have the same focal point which is geometrically located in the virtual picture 44 of the light source 14 arranged in the real focal point.

FIG. 6B shows a frontal view of the optical fiber arrangement with the light-emitting surface 20. The dotted structure within the light-emitting surface 20 represents light distribution lenses that have been integrated there. Analogous this applies to the corrugated course of the light-emitting surface 20 shown in FIG. 6A. The semi-circular profiles 55 shown in FIG. 6B represent edges of the input coupler 16 (here the light-emitting surface of a lens). FIG. 6C shows a lateral view of the optical fiber arrangement and FIG. 6D shows an intersection along the plane d-d sown in FIG. 6A.

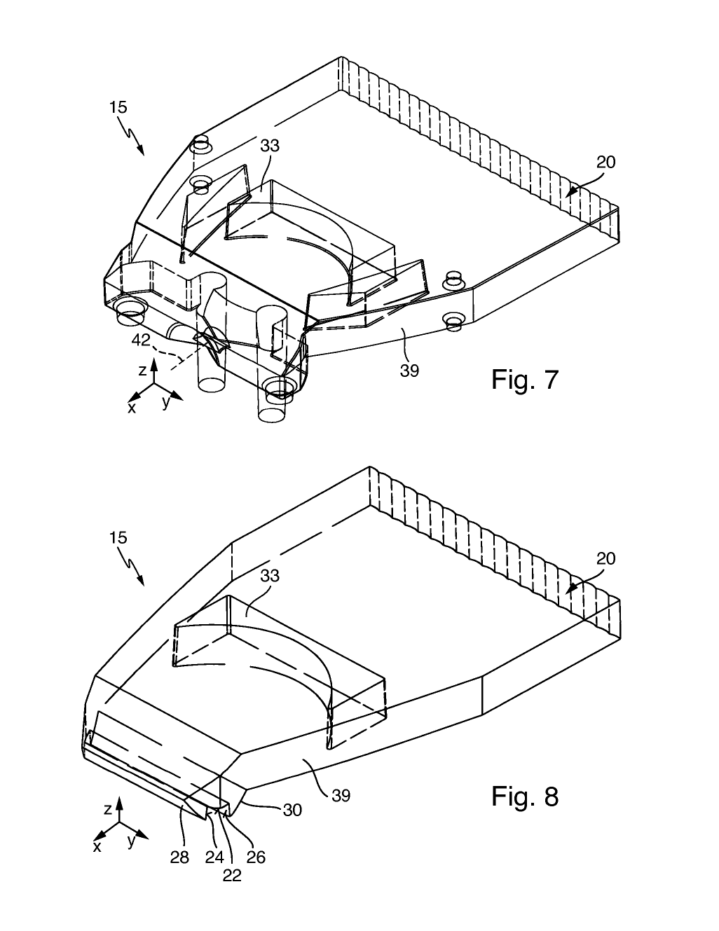

FIG. 7 shows a perspective view of an optical fiber arrangement which has an input coupler with the auxiliary lens profile described above, which is produced by rotating the cross-section shown in FIG. 2. Here the auxiliary lens profile shown in FIG. 2 has been rotated over an angle of 180° about a rotation axis 42 extending parallel to the x-axis.

FIG. 8 shows an alternative embodiment of an optical fiber arrangement with an auxiliary lens profile that has been changed in comparison to FIG. 7. The auxiliary lens profile shown in FIG. 8 is produced by extruding the auxiliary lens profile of 2, i.e., by moving in a linear manner the auxiliary lens profile along the y-axis. The light distribution in the y-z plane differs from the light distribution of the rotated profile of FIG. 7 in that the light distribution in the extruded profile is collimated more than in the rotated profile. Strictly speaking, the light distribution in the rotated profile is not collimated. It extends over an angular width of 180° C. or over the entire angular width of the input light when the angular width of tis light beam is less than 180°.

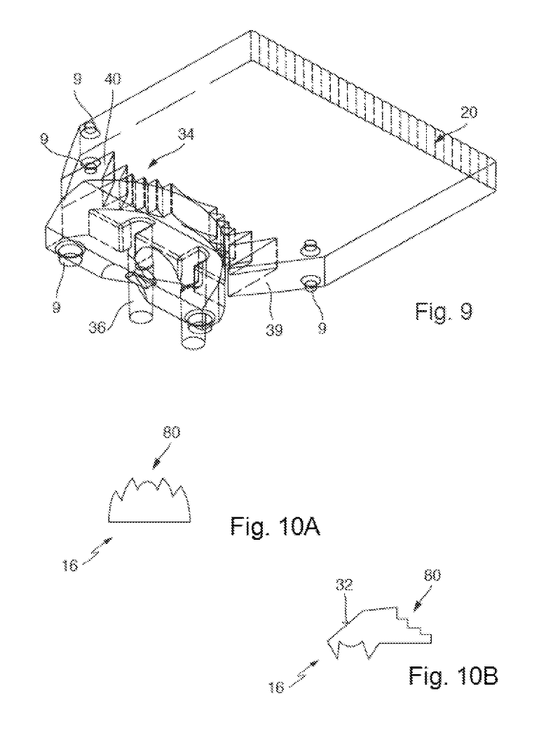

FIG. 9 shows a perspective view of a one embodiment of an optical fiber arrangement in which an internal air lens used as transformation lens 34 is implemented in the form of a Fresnel lens 40. It applies to all embodiments that the coupling modules can be used in the optical fiber arrangement also as separate components.

FIGS. 10A-10B show embodiments of separate coupling modules which include a stepped light-emitting surface. In FIG. 10A, the light-emitting surface is stepped in the plane in which the light is still spreading radially. For example, this is the drawing plane of FIG. 3B. In FIG. 10B, the light-emitting surface is stepped in the radial plane in which the first parallelization has already taken place. For example, this is the drawing plane of FIG. 3D. In FIG. 10A, the light-emitting surface 80 of the input coupler 16 is divided into a plurality of individual surfaces arranged and formed in such a way that, because of refraction, the distribution directions of the light located in the first planes are specifically changed when penetrating an individual surface. As a result, it is possible that an angle of beam of the distribution directions of light located in these planes is specifically changed already during the transition from the input coupler 16 to the transport and transformation lens system. Consequently, it is possible to design the transport and transformation lens system less costly. In particular, it is even possible to eliminate the transformation lenses 34.

In a further embodiment which, based on the coupling module of FIG. 10A, is produced through a combination with the light incidence surface of the transport and transformation lens system formed as negative of the light-emitting surface 80 of the input coupler 26, the resulting interconnections are used as form fit elements for precisely positioning and supporting the input coupler in the transport and transformation lens system.

FIG. 10B shows a further embodiment of the input coupler 16 in a sectional view parallel to the x-z plane. In the embodiment shown, the light output surface 80 of the input coupler 16 is divided into a plurality of individual surfaces. At the same time, the individual surfaces are arranged in steplike manner on top of one another. The steplike arrangement of the individual surfaces allows for a form-fit integration of the input coupler 16 in z-axial direction and x-axial direction into the transport and transformation lens system.

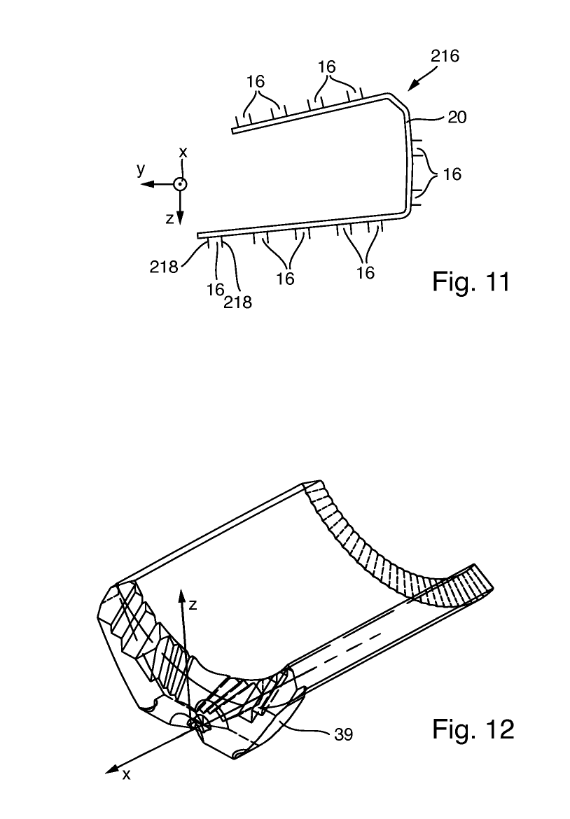

FIG. 11 shows a substantially U-shaped embodiment of the light-emitting surface which is produced by connecting together multiple light-emitting surfaces of individual optical fiber arrangements. In general, it applies that such a light-emitting surface can include an integral component or that it includes multiple components, wherein in both cases multiple coupling modules can be used for light input. FIG. 11 shows an optical fiber 216 in which the light-emitting surface 20 is U-shaped. This is the view an observer would receive in the direction of beam, from a distance on the light-emitting surface. The optical fiber 216 has multiple input coupler 16. The optical fiber 226 can be pictured as optical fiber arrangements 15 primarily arranged next to one another, wherein individual optical fiber arrangements are curved about the x-axis so as to produce the required curvatures. Each of the input couplers 16 has an assigned light source. The optical fiber 216 has support structures 218 which are configured and arranged to attach the light sources with the circuit carrier and the cooling element at the optical fiber. The input couplers 16 are distributed along the light-emitting surface 20 of the optical fiber, ensuring uniform homogenous illumination of the complex band-shaped light-emitting surface 20 with almost parallel light. Moreover, this can also be used to implement different elongated and curved forms.

FIG. 12 shows an embodiment in which it is possible to illuminate homogenously a curved plate with one of the coupling modules presented here, especially with the auxiliary lens like coupling module and respective deflection. The coupling is performed in one of the manners described above. Instead of a purely planar deflection area, a 45° C. prism rotated about the x-axis is used in the area near the z-axis. The rotation can be performed in multiple steps so as to homogenously illuminate the frontal surface. In the subject matter of FIG. 12, a total of seven steps are used. With the 45° C. prism, the light is not only deflected by 90° C., but it is also parallelized. Two deflections are required to homogenously illuminate the outer area further away from the z-axis. The light propagating radially to the outside parallel to the y-z plane is deflected through total reflection at a parabolic section 39 in the outer area and parallelized in the direction of the z-axis. This light needs to be deflected by 90° at further prism sections from the z direction to the x direction. The gradation shown is required for producing the desired homogeneity of the illumination of the light-emitting surfaces.

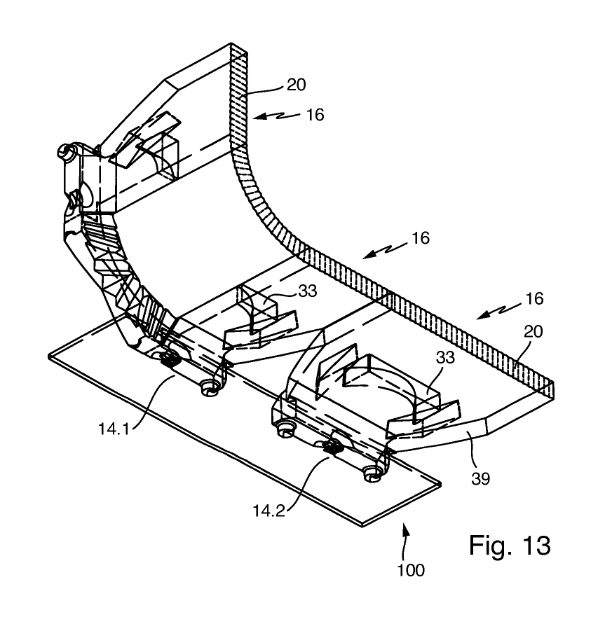

FIG. 13 shows an optical fiber plate which is partially curved and partially planar. Such a plate can be produced through segments of the plate shown in FIG. 12 in combination with the planar embodiments of the transport and transformation lens system described above. Preferably, the combination is performed in such a way that the light sources 14.1 for the curved area are located in the same plane as the light sources 14.2 for the respective planar area so that it is possible to use rigid circuit boards 100 for the curved and planar areas. They are less expensive and easier to handle than flexible circuit boards when producing the invention-based lighting equipments.

The invention has been described in an illustrative manner. It is to be understood that the terminology which has been used is intended to be in the nature of words of description rather than of limitation. Many modifications and variations of the invention are possible in light of the above teachings. Therefore, within the scope of the appended claims, the invention may be practiced other than as specifically described.

What is claimed is:

1. A motor vehicle lighting equipment with a light source and an optical fiber arrangement, which has an input coupler and a transport and transformation lens system, wherein the transport and transformation lens system includes a light-emitting surface, and the input coupler is adapted to transform a light beam emitted by the light source and direct it to the transport and transformation lens system, wherein the input coupler has at least one curved light beam forming surface which has a lens-shaped profile, which reduces the angle of beam of the light when penetrating this surface, and wherein the transport and transformation lens system has transformation lenses that have a mutual focal point, and the light source is arranged in the mutual focal point, wherein the light source is arranged on the side of the optical fiber arrangement located opposite of the light-emitting surface in such a way that:
all areas of the optical fiber arrangement conducting light from the light source are located between the light source and the light-emitting surface, and
the optical fiber arrangement has at least a planar deflection area arranged between the curved surfaces of the input coupler and the transformation lenses.

2. The motor vehicle light equipment as set forth in claim 1, wherein the curved light beam forming surface has in first sectional planes semi-circular edges with central points located on an axis the light source is located on, and which surfaces have in second sectional planes a lens-shaped profile.

3. The motor vehicle light equipment as set forth in claim 1, wherein the input coupler has a lens and the light-emitting surface of the lens is a curved light beam forming surface.

4. The motor vehicle light equipment as set forth in claim 1, wherein the input coupler has an auxiliary lens with a central light incidence surface, lateral light incidence surfaces, and lateral reflection areas, wherein the central light incidence surface is a curved light beam forming surface.

5. The motor vehicle light equipment as set forth in claim 1, wherein the input coupler has an auxiliary lens with a central light incidence surface, lateral light incidence surfaces, and lateral reflection areas, wherein the lateral reflection area is a curved light beam forming surface.

6. The motor vehicle light equipment as set forth in claim 1, wherein the input coupler and the transport and transformation lens system are integrally formed firmly bonded components of the optical fiber arrangement.

7. The motor vehicle light equipment as set forth in claim 1, wherein the input coupler and the transport and transformation lens system are separate components which are detachably connected with the optical fiber arrangement.

8. The motor vehicle light equipment as set forth in claim 1, wherein the deflection area is part of a separate input coupler component of the optical fiber arrangement.

9. The motor vehicle light equipment as set forth in claim 1, wherein the deflection area is part of a separate transport and transformation lens system component of the optical fiber arrangement.

10. The motor vehicle light equipment as set forth in claim 1, wherein the transformation lenses are implemented in the form of at least one of a central air lenses, and/or that it is implemented in the form of parabolic and internally fully reflective boundary surfaces of inner recesses, and parabolic and internally fully reflective outer reflectors.

11. The motor vehicle light equipment as set forth in claim 1, wherein all transformation lenses have the same focal point.

12. The motor vehicle light equipment as set forth in claim 1, wherein the light-emitting surface has integrated distribution lenses.

13. The motor vehicle light equipment as set forth in claim 1, wherein the shape of a spatial auxiliary lens profile is produced by extruding a planar auxiliary lens profile.

14. The motor vehicle light equipment as set forth in claim 1, wherein the form of a spatial auxiliary lens profile is produced by rotating a planar auxiliary lens profile.

15. The motor vehicle light equipment as set forth in claim 1, wherein a transformation lens 34 used as an internal air lens is implemented in the form of a Fresnel lens.

16. The motor vehicle light equipment as set forth in claim 1, wherein the light source has multiple light-emitting diodes that generate light of the same color.

17. The motor vehicle light equipment as set forth in claim 1, wherein the input coupler and the transport and transformation lens system are separate components which are non-detachably connected with the optical fiber arrangement.

18. The motor vehicle light equipment as set forth in claim 1, wherein the light source has multiple light-emitting diodes that generate light with different colors, wherein one light-emitting diode, respectively, generates light of one particular color.
